(19) United States
(12) Patent Application Publication
(10) Pub. No.: US 2012/0222573 A1
(43) Pub. Date: Sep. 6, 2012

(54) PAD STRUCTURE FOR PAD PRINTING MACHINE

(75) Inventor: HON-CHUN WU, Shindian (TW)

(73) Assignee: FIH (HONG KONG) LIMITED, Kowloon (HK)

(21) Appl. No.: 13/211,758

(22) Filed: Aug. 17, 2011

(30) Foreign Application Priority Data
Mar. 4, 2011 (CN) 201110052922.3

(51) Int. Cl. B41K 1/42

(52) U.S. Cl. 101/333

(57) ABSTRACT

A pad structure includes a holding plate, a pad and a skin. The pad is formed on the holding plate. The pad is made of a first type material. The skin is directly formed on the pad and is made of a second type material. The skin can be peeled and removed from the pad.

### BACKGROUND

1. Technical Field

The present disclosure generally relates to pad printing machines, and particularly to a pad structure of a pad printing machine.

2. Description of Related Art

Pad printing is a printing process conducted using the combination of a printing plate called a cliche, special pad printing inks, and a pad. The pad picks up the image from the cliche and transfers it to the item (substrate) being printed on. This pad is capable of conforming to the shape of the item being printed.

However, the pad is usually an inseparable/indivisible part of a pad support assembly that allows the pad to be mounted to a pad printing machine. When the pad is damaged, the whole pad assembly needs to be replaced, which can be expensive.

Therefore, there is room for improvement within the art.

### BRIEF DESCRIPTION OF THE DRAWINGS

Many aspects of the pad structure of a pad printing machine can be better understood with reference to the following drawings. The components in the drawings are not necessarily to scale, the emphasis instead being placed upon clearly illustrating the pad structure of pad printing machine. Moreover, in the drawings, like reference numerals designate corresponding parts throughout the several views.

FIG. 1 is a schematic view of a pad structure applied in a pad printing machine according to an exemplary embodiment.

FIG. 2 is a schematic view of the pad structure of FIG. 1.

FIG. 3 is a schematic view of the pad structure of FIG. 2 after a skin is formed thereon.

FIG. 4 is a bottom view of the pad structure of FIG. 3.

FIG. 5 is a cross-sectional view of the pad structure taken along line V-V of FIG. 4.

### DETAILED DESCRIPTION

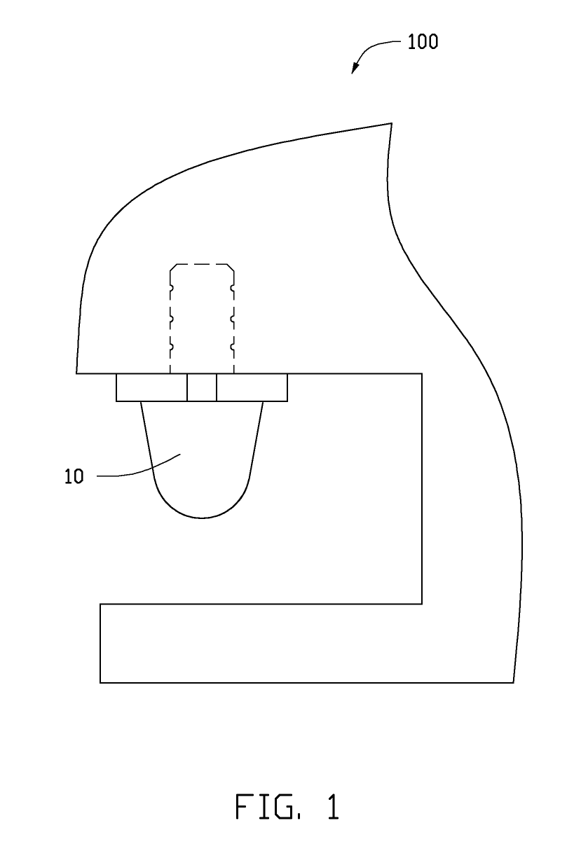

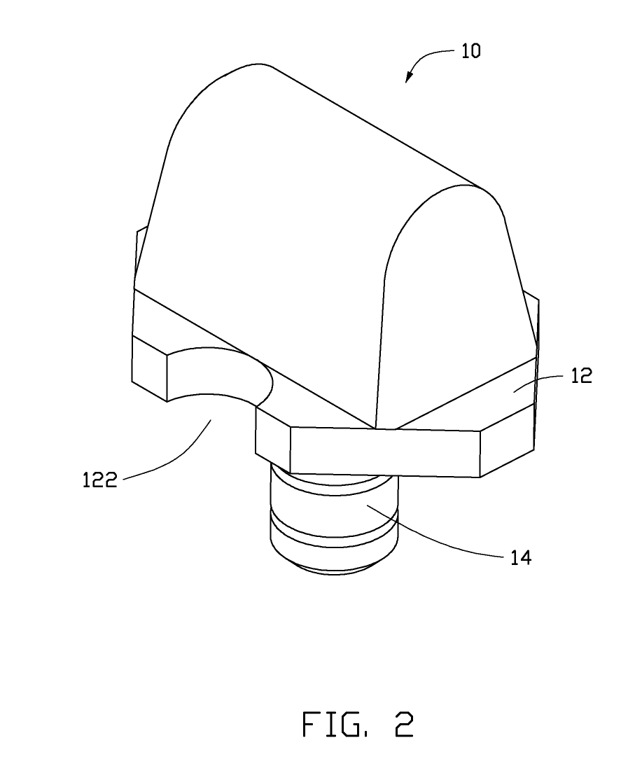

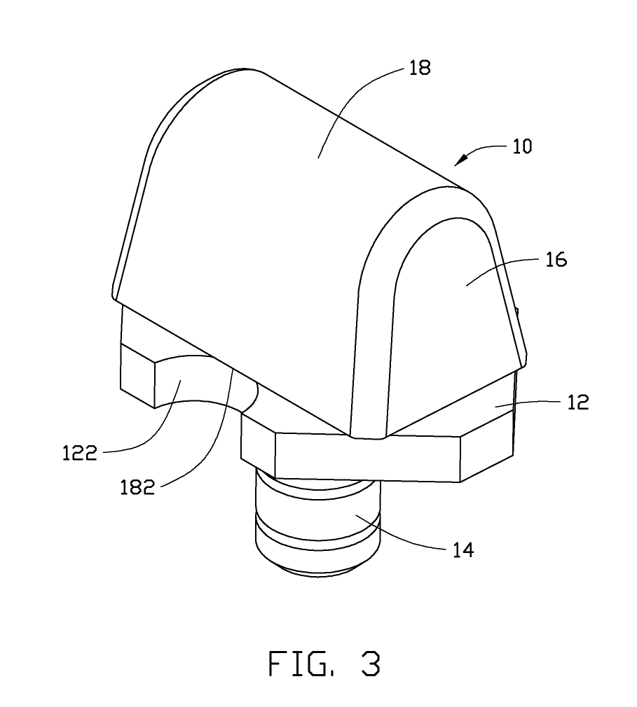

FIG. 1 shows an exemplary embodiment of a pad printing machine 100 including a pad structure 10. The pad structure 10 can be assembled to the pad printing machine 100. Referring to FIGS. 2 and 3, the pad structure 10 includes a holding plate 12, a connecting shaft 14, a pad 16, and a skin 18. The connecting shaft 14 is mounted to one surface of the holding plate 12, and the pad 16 is formed on the opposite surface of the holding plate 12. The skin 18 is formed on the pad 16.

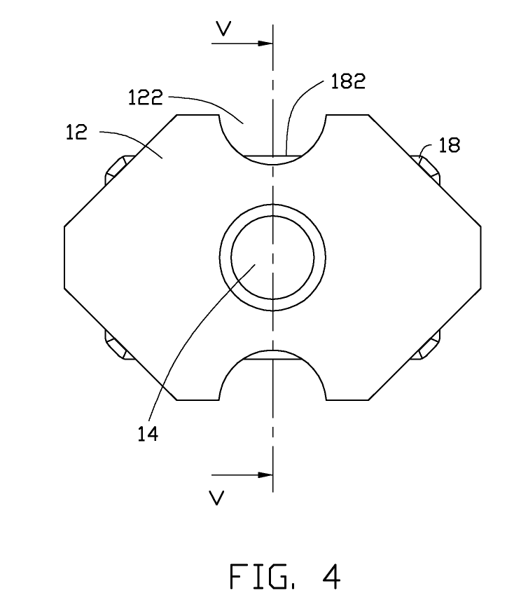

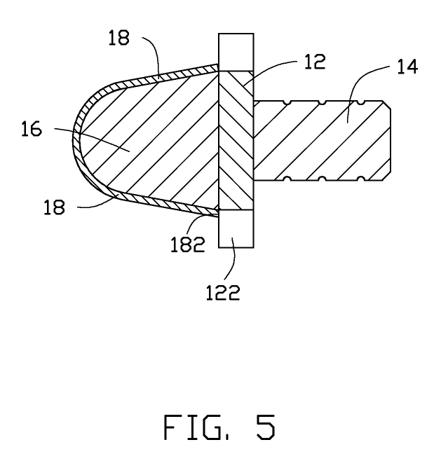

Referring to FIGS. 4 and 5, the holding plate 12 is substantially an irregular polygon, and defines two notches 122 for venting gas during formation of the skin 18. In this embodiment, the connecting shaft 14 is a bolt that can be screwed into the pad printing machine 100.

The pad 16 is made of a first material. The skin 18 is made of a second material different from the first material. In this exemplary embodiment, the first material and the second material are different types of silicone rubber, for example, a first type and a second type. The second type of silicon rubber is more expensive, but also more wear resistant, than the first type. Thus, the material costs involved with refurbishing a pad structure are greatly reduced. That is, the more expensive and wear resistant material is used for portions of the pad in contact with ink and the surfaces being printed on. As this is a high wear inducing environment, the more wear resistant material need be used. The underlying pad 16 is protected from the wear inducing environment by the skin, and therefore does not need to be made from wear resistant materials.

The skin 18 is directly formed on the pad 16. The skin 18 has a bottom brim. The bottom brim has portions to be exposed from the notches 122 to form two grip portions 182. When the skin 18 is damaged in any way, the skin 18 may be easily peeled and removed from the grip portions 182 and replaced with a new piece of skin 18.

The method of forming the skin 18 may include the following steps: first, the pad 16 is positioned in a molding cavity. Then, molten material such as rubber is fed into the molding cavity to gradually cover the pad 16 until the molten material is filled into the molding cavity. Any gas in the molten rubber is vented through the notches 122. After the rubber hardens on the pad 16, the pad 16 can be taken out from the molding cavity. Accordingly, the pad 16 is covered with a layer of rubber to form the skin 18.

When the pad structure 10 is damaged, the skin 18 may be easily peeled and removed, and another skin 18 formed on the pad 16 again. Thus, the pad 16 may be repeatedly used, and this may avoid replacing the whole pad structure 10. Thus, the manufacturing costs are greatly reduced.

It is to be understood, however, that even through numerous characteristics and advantages of the present disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A pad structure comprising:
a holding plate
a pad formed on the holding plate, the pad made of a first type material;
a skin directly formed on the pad and is made of a second type material, wherein the skin can be peeled and removed from the pad.

2. The pad structure as claimed in claim 1, wherein the skin includes a plurality of grip portions, from which the skin is peeled and removed.

3. The pad structure as claimed in claim 1, wherein the holding plate includes a plurality of notches, the skin has a bottom brim having portions to be exposed from the notches to form the grip portions.

4. The pad structure as claimed in claim 1, further comprising a connecting shaft, wherein the connecting shaft is mounted to the holding plate opposite to the pad.

5. The pad structure as claimed in claim 1, wherein the first type material and the second type material are different types of silicone rubber.

6. A pad printing machine comprising:
a body;
a pad structure mounted to the body, the pad structure comprising:
a holding plate;
a pad formed on the holding plate;
a skin directly formed on the pad, wherein the skin can be peeled and removed from the pad.

7. The pad printing machine as claimed in claim 6, wherein the pad is made of a first material, and the skin is made of a second material.

8. The pad printing machine as claimed in claim 6, wherein the first type material and the second type material are different types of silicone rubber.

9. The pad printing machine as claimed in claim 6, wherein the skin includes a plurality of grip portions, from which the skin is peeled and removed.

10. The pad printing machine as claimed in claim 9, wherein the holding plate includes a plurality of notches, the skin has a bottom brim having portions to be exposed from the notches to form the grip portions.

11. The pad printing machine as claimed in claim 6, further comprising a connecting shaft, wherein the connecting shaft is mounted to the holding plate opposite to the pad.
